(19) United States
(12) Patent Application Publication
(10) Pub. No.: US 2011/0277277 A1
(43) Pub. Date: Nov. 17, 2011

(54) Fastener for heat sink

(75) Inventors: Lien-Hsing Chen, Taichung County (TW); Hui-Hung Hsiang, Taichung County (TW)

(73) Assignee: POWER MATE TECHNOLOGY CO., LTD., Taichung (TW)

(21) Appl. No.: 12/801,007

(22) Filed: May 17, 2010

(51) Int. Cl. F16B 2/00

(52) U.S. Cl. 24/298

(57) ABSTRACT

A fastener for fastening a heat sink and a heat-generating element includes a bended flexible main body, an upper hook portion, and a lower hook portion. The heat sink includes a plurality of fins. The upper hook portion extends from an upper end of the main body for matching the fins and hooking the heat sink. The lower hook portion extends from a lower end of the main body for hooking the heat-generating element.

### BACKGROUND OF THE INVENTION

1. Field of the Invention

The present invention relates generally to a fastener, and more particularly, to a fastener for a heat sink.

2. Description of the Related Art

For the electronic equipment, thermal dissipation is very crucial because the electronic elements inside is vulnerable to high waste heat generated due to rising temperature while they are working. The electronic elements may malfunction or even be damaged if they are not working under proper temperature.

In light of the above, a heat sink clinging to an electronic element was developed to effectively dissipate the waste heat generated by the electronic element. Such conventional heat sink is mounted to a holder of the electronic element by a fastener which can engage the holder to force the heat sink to cling to the elements. However, how such conventional heat sink is mounted to the electronic element is not only complicated in operation but also increases the material cost, assembly cost, and design complexity, thus being unfavorable to the manufacturers of the electronic equipments.

### SUMMARY OF THE INVENTION

The primary objective of the present invention is to provide a fastener, which can force a heat sink to cling to a heat-generating element without any holder.

The foregoing objective of the present invention is attained by the fastener composed of a bended flexible main body, an upper hook portion, and a lower hook portion. The heat sink includes a plurality of fins. The upper hook portion extends from an upper end of the main body for matching the fins and hooking the heat sink. The lower hook portion extends from a lower end of the main body for hooking the heat-generating element.

### BRIEF DESCRIPTION OF THE DRAWINGS

FIG. 1 is a schematic view of a first preferred embodiment of the present invention in connection with the heat-generating element and the heat sink.

FIG. 2 is a perspective view of the first preferred embodiment of the present invention.

FIG. 3 is a perspective view of the first preferred embodiment of the present invention in operation.

FIG. 4 is a perspective view of a second preferred embodiment of the present invention.

FIG. 5 is a perspective view of a third preferred embodiment of the present invention.

### DETAILED DESCRIPTION OF PREFERRED EMBODIMENTS

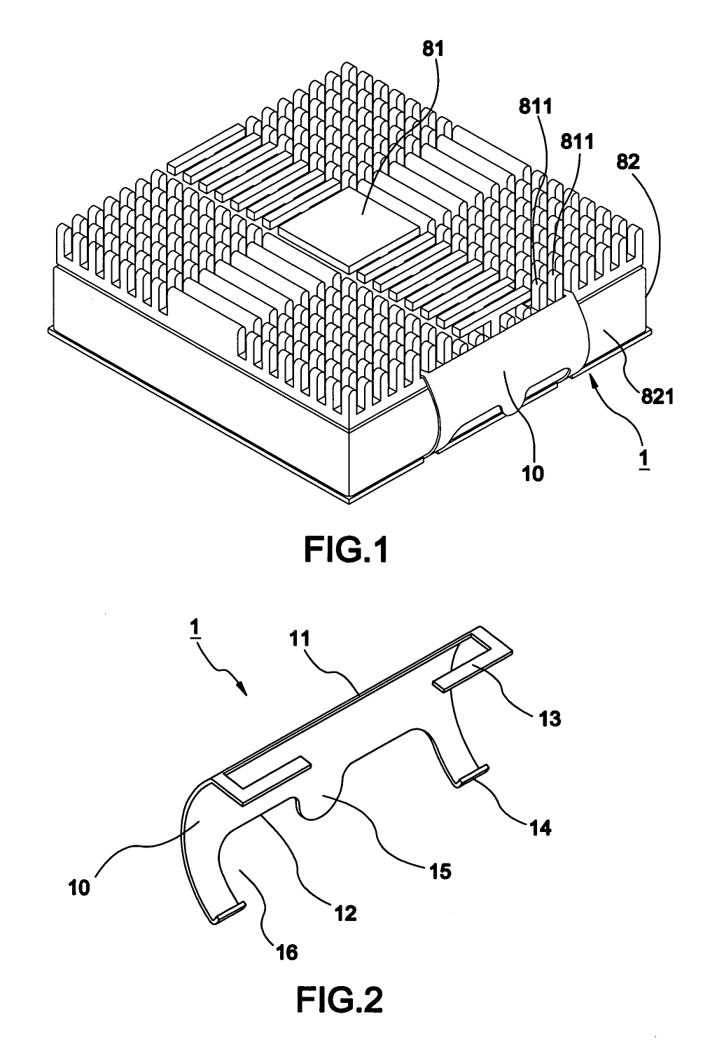

Referring to FIGS. 1-2, a fastener 1 constructed according to a first preferred embodiment of the present invention, for fastening a heat sink 81 and a heat-generating element 82 to each other, includes a bended flexible main body 10. The heat sink 81 is composed of a plurality of fins 811. The detailed descriptions and operations of these elements as well as their interrelation are recited in the respective paragraphs as follows.

The flexible main body 10 is bended and includes an upper end 11, and a lower end 12. Two upper hook portions 13 extend from the upper end 11 of the main body 10 for matching the fins 811 and hooking the heat sink 81. One lower hook portion 14 extends from the lower end 12 of the main body 10 for hooking the heat-generating element 82. In this embodiment, to facilitate operation for the user, an operation piece 15 is formed at the lower end 12 of the main body 10 and the user can operate the operation piece 15 to separate the main body 10 from the heat sink 81 and the heat-generating element 82. The main body 10 further includes a recessed portion 16 from the lower end 12. The operation piece 15 extends into the recessed portion 16.

It is to be noted that the lower hook portion 14 can hook a bottom end of the heat-generating element 82. In fact, the heat-generating element 82 has four sidewalls 821, each of which is formed at one of four sides thereof. The lower hook portion 14 can also hook one of the sidewalls 821.

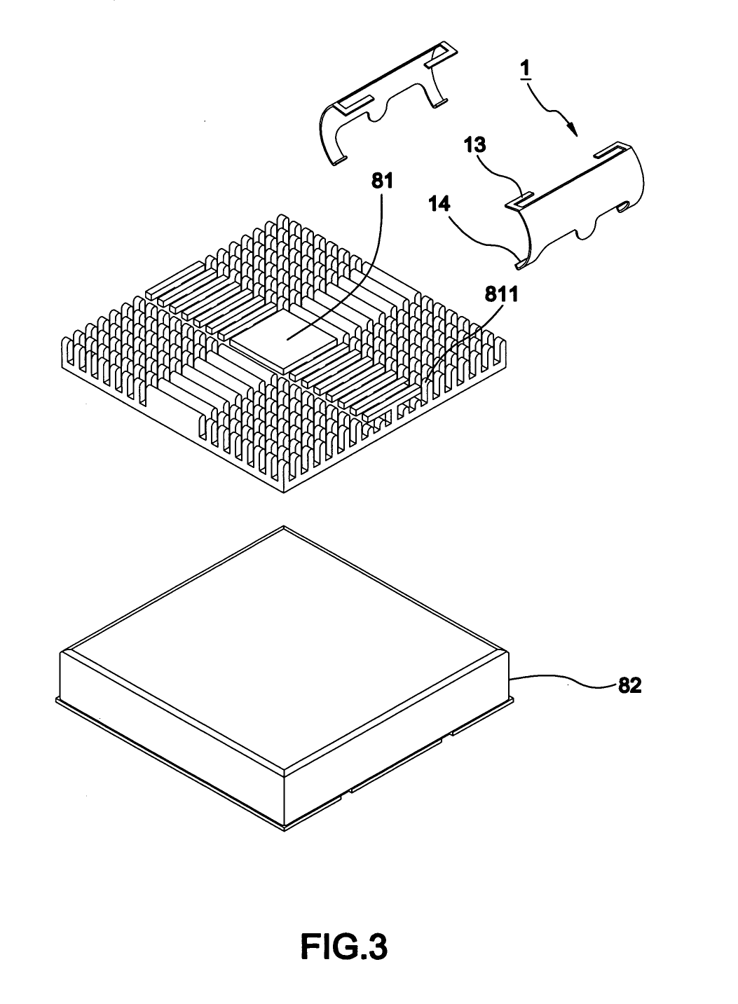

Referring to FIG. 3, when the user intends to enable the heat sink 81 to cling to the heat-generating element 82, the user can let the upper hook portion 13 hook the fins 811 and let the lower hook portion 14 hook the bottom end of one of the sidewalls 821 to enable the fastener 1 to force the tightness between the heat sink 81 and the heat-generating element 82. If the user intends to separate the fastener 1 from the heat sink 81 and the heat-generating element 82, the user can operate a tool, like a screwdriver or pliers, to wrench the operation piece 15 to further disengage the lower hook portion 14 from the heat-generating element 82 and then remove the fastener 1 from the heat sink 81.

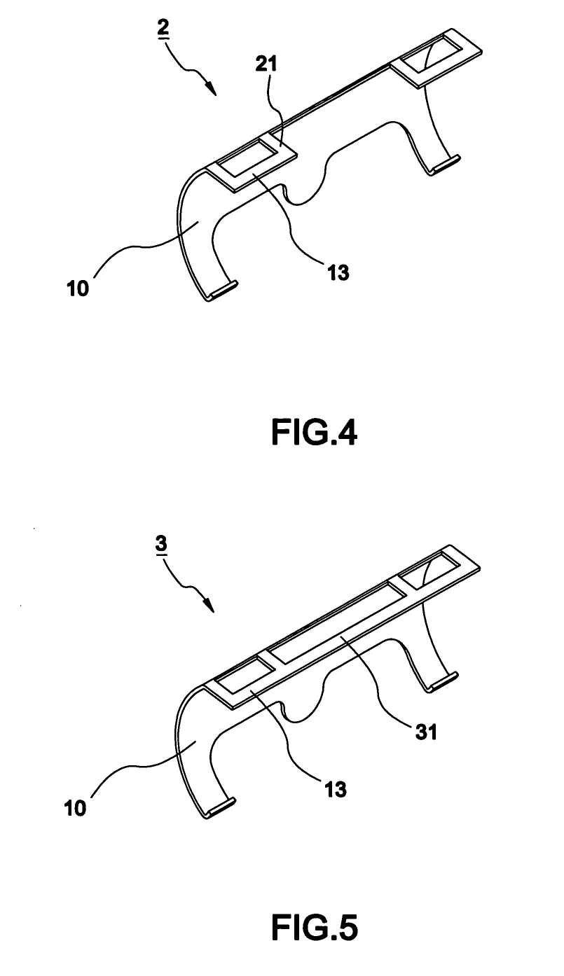

Referring to FIG. 4, a fastener 2 constructed according to a second preferred embodiment of the present invention is similar to that of the first embodiment, having the following difference. The flexible main body 10 of the second embodiment further includes a first reinforcing member 21 extending from the upper end and connected with the upper hook portion 13. How the second embodiment is operated is identical to that of the first embodiment, such that no more recitation is necessary.

Referring to FIG. 5, a fastener 3 constructed according to a third preferred embodiment of the present invention is similar to that of the second embodiment, having the following difference. There are a plurality of the upper hook portions 13. The flexible main body 10 further includes a second reinforcing member 31 connected with the upper hook portion 13. How the third embodiment is operated is identical to that of the first embodiment, such that no more recitation is necessary.

Although the present invention has been described with respect to specific preferred embodiments thereof, it is in no way limited to the specifics of the illustrated structures but changes and modifications may be made within the scope of the appended claims.

What is claimed is:

1. A fastener for fastening a heat sink and a heat-generating element, the heat sink having a plurality of fins, the fastener comprising a bended flexible main body, the main body having an upper end, a lower end, an upper hook portion extending from the upper end and matching the fins for hooking the heat sink, and a lower hook portion extending from the lower end for hooking the heat-generating element.

2. The fastener as defined in claim 1, wherein the flexible main body further comprises an operation piece extending from the lower end.

3. The fastener as defined in claim 2, wherein the flexible main body further comprises a recessed portion formed at the lower end, and the operation piece extends into the recessed portion.

4. The fastener as defined in claim 1, wherein the flexible main body further comprises a first reinforcing member extending from the upper hook portion and connected with an upper end of the main body and the upper hook portion.

5. The fastener as defined in claim 4, wherein the upper hook portion is plural in number, and the flexible main body further comprises a second reinforcing member connected with each of the upper hook portions.

6. The fastener as defined in claim 1, wherein the heat-generating element comprises four sidewalls, each of which is formed at four sides of the heat-generating element; the lower hook portion can hook one of the sidewalls.

7. The fastener as defined in claim 6, wherein the lower hook portion can hook a bottom end of one of the sidewalls.
